(19) United States
(12) Patent Application Publication
(10) Pub. No.: US 2004/0040428 A1
(43) Pub. Date: Mar. 4, 2004

(54) Garlic bread slicer

(76) Inventors: Perry R. DeYoung, Grand Rapids, MI (US); Bernard L. Petersen, Marne, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/465,738

(22) Filed: Jun. 19, 2003

Related U.S. Application Data
(60) Provisional application No. 60/389,792, filed on Jun. 19, 2002.

(51) Int. Cl. B26D 7/06

(52) U.S. Cl. 83/165; 83/444; 83/449

(57) ABSTRACT

A food slicer comprising a base having a slanted chute, a cutting blade housing and a cutting blade extending into the chute. The chute comprises a first panel having a first wall and a second panel having a second wall. Food is placed into a top of the chute and forced to slide to a bottom of the chute by gravity to cut the food with the cutting blade. The first panel and the second panel define a cavity having a uniform cross section. The first panel is adjustably positioned relative to the second panel, whereby the first wall can be moved towards and away from the second wall, thereby altering the size of the cavity in the chute. The food slicer can be placed on a mobile cart and connected thereto to thereby allow easy transportation of the food slicer.

### CROSS-REFERENCE TO RELATED APPLICATION

The present invention claims priority to Provisional Patent Application Serial No. 60/389,792, filed on Jun. 19, 2002 entitled GARLIC BREAD SLICER.

### BACKGROUND OF THE INVENTION

The present invention relates to food slicers, and in particular to a garlic bread slicer.

Food slicers are used to slice food. Examples of food slicers are those used to slice bread, slice bagels, slice buns and slice garlic bread. The food slicers can cut all the way through the food or only partially through the food to leave the food with a hinge. The food slicers at least partially divide the food to allow meats, spreads, garlic and other edible items to be placed on the sliced food.

Heretofore, food slicers have included the Gourmet Bun Slicer Models 704N, 700, 702 and 702N sold by Oliver Products Company of Grand Rapids, Mich. The Gourmet Bun Slicer Models 704N, 700, 702 and 702N included a frame having a chute with a blade extending into the chute. Food is sliced by placing the food in the chute, whereby gravity pulls the food through the chute and the blade slices the food as the food goes through the chute. The Gourmet Bun Slicer Models 704N, 700, 702 and 702N included several guides for the chute, thereby allowing a user of the Gourmet Bun Slicer Models 704N, 700, 702 and 702N to change all of the dimensions of the chute to accommodate food of various dimensions. However, the versatility of the Gourmet Bun Slicer Models 704N, 700, 702 and 702N required many parts and a corresponding price. Furthermore, the Gourmet Bun Slicer Models 704N, 700, 702 and 702N typically had to be set in position or carried from a storage position to a use position. At approximately 160 pounds, moving the Gourmet Bun Slicer Models 704N, 700, 702 and 702N could become difficult.

Accordingly, an inexpensive and mobile food slicer solving the aforementioned disadvantages and having the aforementioned advantages is desired.

### SUMMARY OF THE INVENTION

One aspect of the present invention is to provide a food slicer comprising a base having a slanted chute and a cutting blade housing. The slanted chute comprises a first panel and a second panel, with the first panel including a first wall and the second panel including a second wall. The first wall faces the second wall. The cutting blade housing includes a cutting blade extending into the chute. Food can be placed into a top of the slanted chute and be forced to slide to a bottom of the chute by gravity, whereby the food placed into the slanted chute is sliced by the cutting blade as the food slides through the slanted chute. The first panel and the second panel of the slanted chute define a cavity for receiving food therein. The first panel is adjustably positioned relative to the second panel whereby the first wall of the first panel can be towards and away from the second wall of the second panel, thereby altering the size of the cavity in the slanted chute. The cavity has a uniform cross section from the top of the chute to the bottom of the chute.

Another aspect of the present invention is to provide a mobile food slicer assembly comprising a base having a slanted chute and a cutting blade housing. The cutting blade housing includes a cutting blade extending into the chute. The base further includes apertures in a bottom thereof. The mobile food slicer also includes a mobile cart having wheels on a bottom thereof and a top frame member, with the top frame member including a plurality of openings. The openings and the apertures are configured to accept fasteners therethrough to connect the base to the mobile cart to thereby allow easy transportation of the base on the mobile cart and to steady the base during use of the cutting blade. Food can be placed into a top of the slanted chute and be forced to slide to a bottom of the chute by gravity, whereby the food placed into the slanted chute is sliced by the cutting blade as the food slides through the slanted chute.

Yet another aspect of the present invention is to provide a mobile food slicer assembly including a base comprising a slanted chute and a cutting blade housing, with the base including apertures in a bottom thereof. The slanted chute comprises a first panel and a second panel, with the first panel including a first wall and the second panel including a second wall. The first wall faces the second wall. The cutting blade housing includes a cutting blade extending into the chute. The mobile food slicer assembly also includes a mobile cart having wheels on a bottom thereof and a top frame member, with the top frame member including a plurality of openings. The openings and the apertures are configured to accept fasteners therethrough to connect the base to the mobile cart to thereby allow easy transportation of the base on the mobile cart and to steady the base during use of the cutting blade. Food can be placed into a top of the slanted chute and be forced to slide to a bottom of the chute by gravity, whereby the food placed into the slanted chute is sliced by the cutting blade as the food slides through the slanted chute. The first panel and the second panel of the slanted chute define a cavity for receiving food therein. The first panel is adjustably positioned relative to the second panel whereby the first wall of the first panel can be towards and away from the second wall of the second panel, thereby altering the size of the cavity in the slanted chute. The cavity has a uniform cross section from the top of the chute to the bottom of the chute.

These and other features, advantages, and objects of the present invention will be further understood and appreciated by those skilled in the art by reference to the following specification, claims and appended drawings.

### BRIEF DESCRIPTION OF THE DRAWINGS

FIG. 1 is a front view of the garlic bread slicer of the present invention.

FIG. 2 is a rear view of the garlic bread slicer of the present invention.

FIG. 3 is a left side view of the garlic bread slicer of the present invention.

FIG. 4 is a right side view of the garlic bread slicer of the present invention.

FIG. 5 is a cross-sectional view of a bread chute of the present invention.

FIG. 6 is a bottom view of a support plate of a mobile cart of the present invention.

FIG. 7 is an angled bottom view of the support plate of the mobile cart of the present invention.

FIG. 8 is an isometric top view of the support plate of the mobile cart of the present invention.

FIG. 9 is a front view of the mobile cart of the present invention.

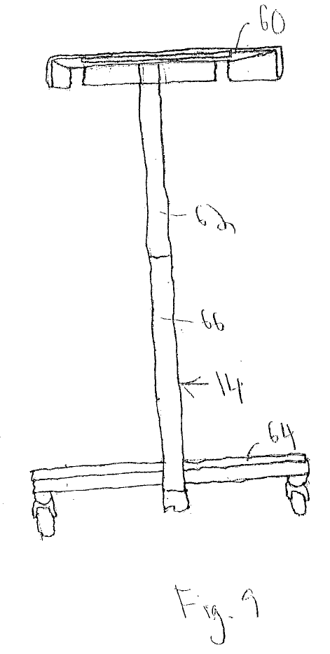

### DETAILED DESCRIPTION OF THE PREFERRED EMBODIMENTS

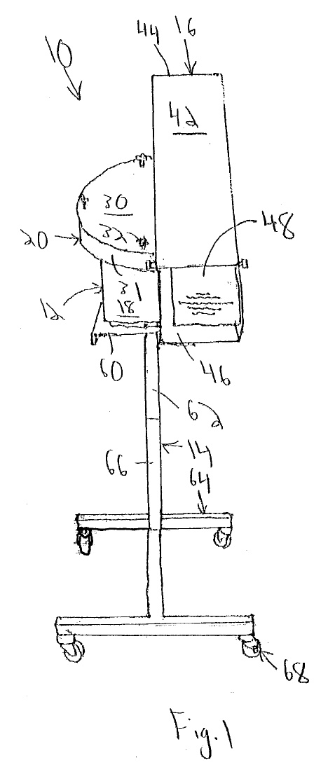

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

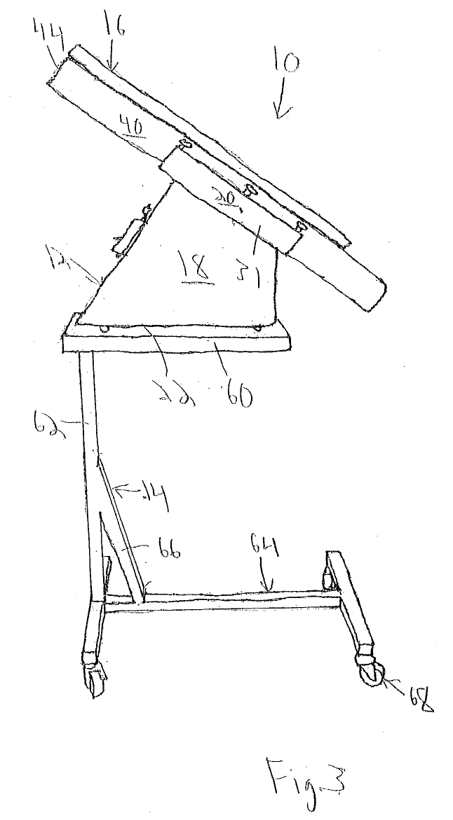

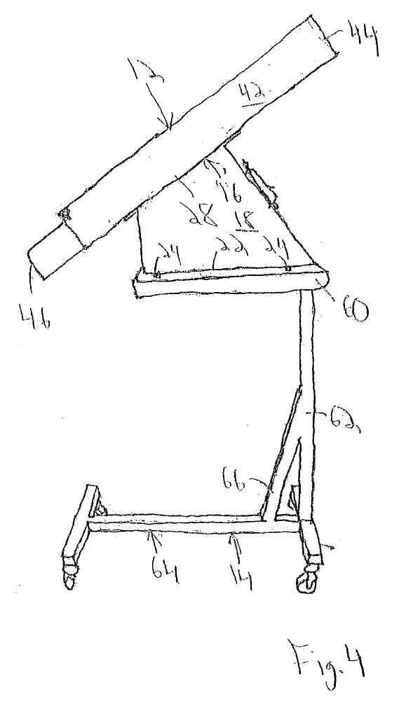

The reference number 10 (FIGS. 1-4) generally designates a garlic bread slicer of the present invention. The garlic bread slicer 10 includes a cutting assembly 12 and a mobile base 14 for the cutting assembly 12. The cutting assembly 12 includes a bread chute 16 configured to cut bread placed therein into a top half, a bottom half and a hinge connecting the two halves.

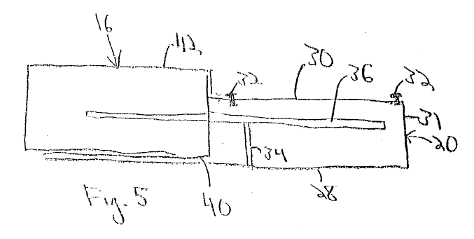

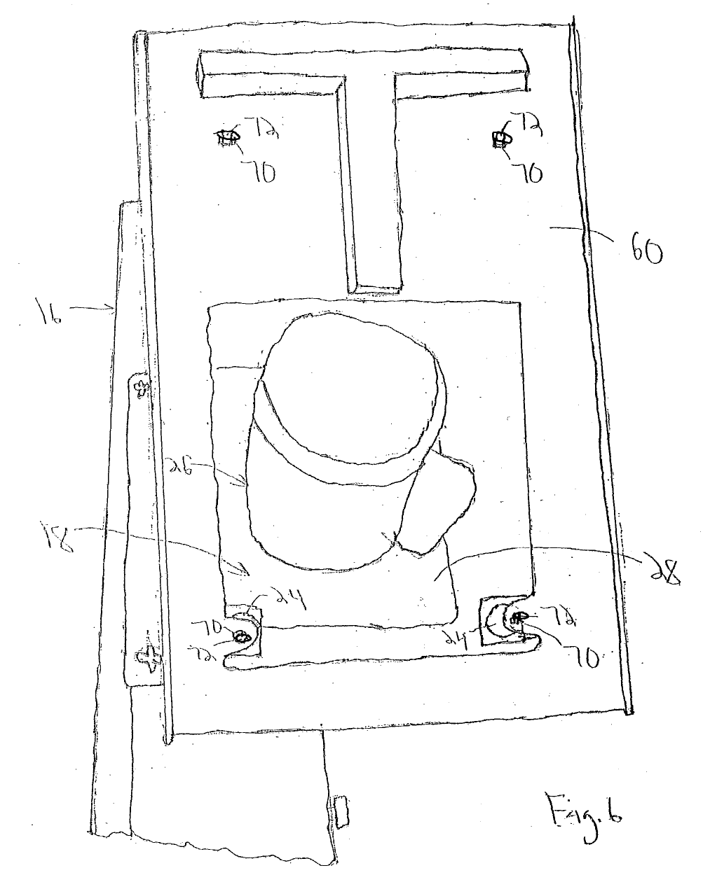

The cutting assembly 12 includes a motor housing 18, a blade housing 20 and the bread chute 16. The motor housing 18 includes a rectangular bottom 22 having four brackets 24 with threaded apertures. As illustrated in FIG. 6, the motor housing 18 houses a motor 26. The motor 26 as described in this application is commercially available from Leeson Electric located in Grafton, Wis., under the Model No. C6C17FC5F. Those skilled in the art will appreciate that other similarly functioning motors may be used. The motor housing 18 includes an angled upper support plate 28. The chute 16 and the blade housing 20 are connected to the upper plate 28. The blade housing 20 includes a semi-circular shell 31 and a removable top lid 30. The removable top lid 30 includes openings for accepting screws extended from the semi-circular shell 31. Knobs 32 are screwed onto the screws to connect the top lid 30 to the semi-circular shell 31. As illustrated in FIG. 5, the motor 26 includes an output rod 34 that extends through the upper plate 28 and into the blade housing 20. A circular cutting blade 36 is connected to the output rod 34. The cutting blade 36 also extends partially into the chute 16. When the garlic bread slicer 10 is powered by turning on an “on” switch 38 on the motor housing 18, the motor 26 will rotate the output rod 34 and the cutting blade 36 to cut bread placed into the chute 16.

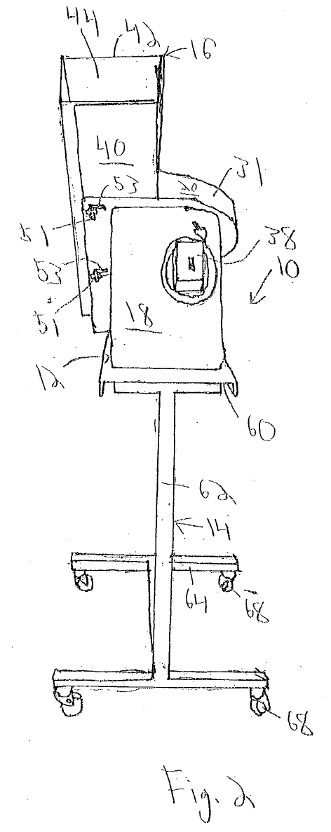

The chute 16 includes a bottom L-shaped plate 40 connected to the upper plate 28 of the motor housing 18 and an upper C-shaped bracket 42. As illustrated in FIG. 2, screw clamps 51 extend from a bottom of the upper bracket 42 and through slots 53 in the upper plate 28 for allowing the width of the chute 16 to change, thereby changing the depth of the cut of the bread placed into the chute 16. The chute 16 includes an entry port 44 for insertion of unsliced bread and an exit 46 for removal of the sliced bread. The exit 46 preferably includes a friction plate 48 connected to the upper bracket 42 for slowing the speed of bread coming from the chute 16.

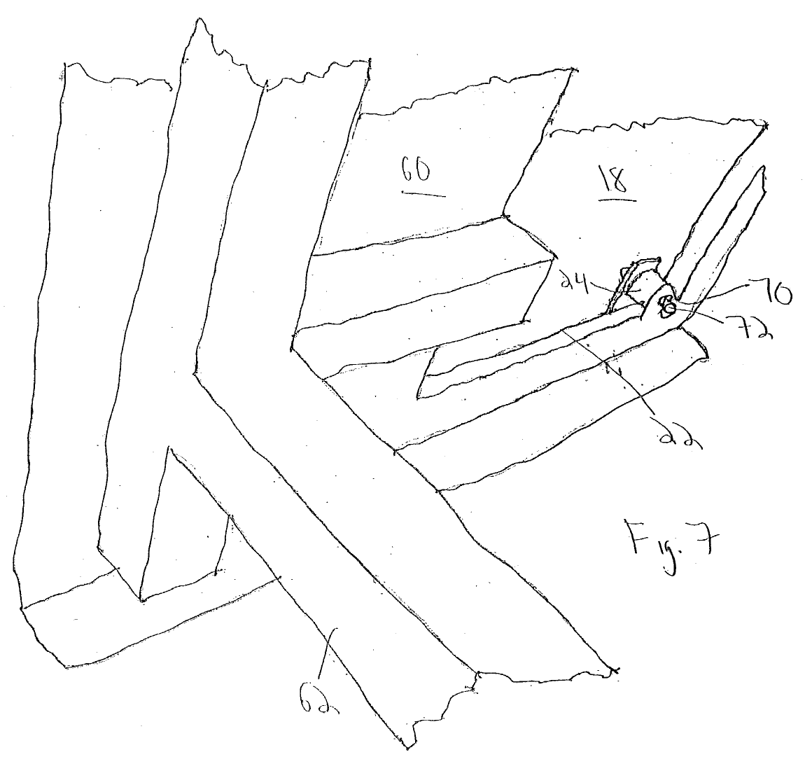

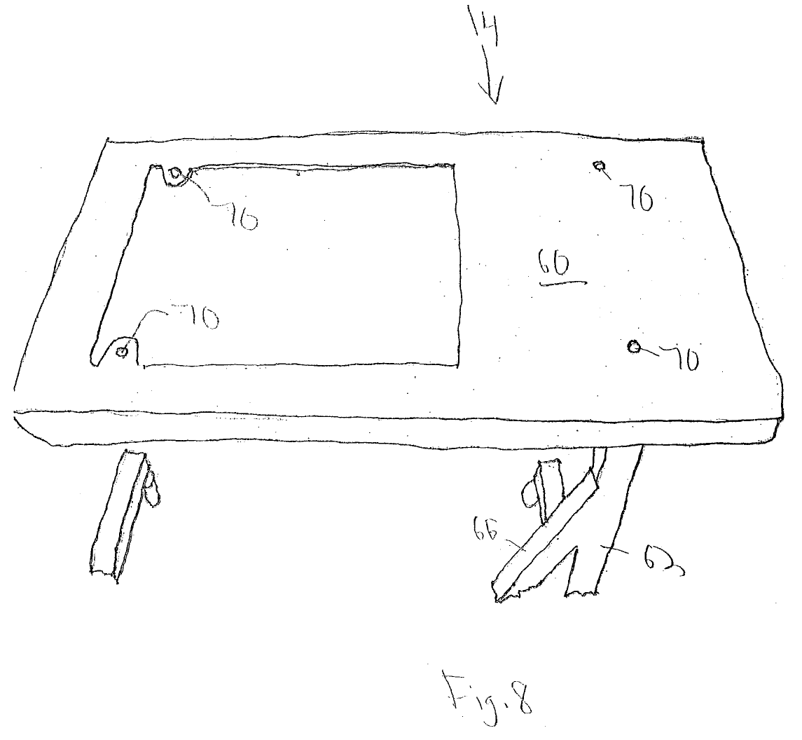

The mobile base 14 includes an upper plate 60, a support bar 62 and a bottom I-shaped base 64. A support bar 66 also extends between the bar 62 and the base 64. As shown in FIG. 2, the I-shaped base 64 includes castors 68 connected to a bottom thereof. The wheels of castors 68 preferably can be locked into place to prevent the mobile base 14 from moving. It is contemplated that other feet, such as rubber pads, may depend from the I-shaped base 64 to prevent the base 14 from moving. The upper plate 60 includes four openings 70 therethrough (see FIGS. 6-8). Screws 72 extend through the openings 70 from underneath the openings 70 and are screwed into the threaded apertures in the bottom of the cutting assembly 12 to connect the cutting assembly 12 to the mobile base 14. It is contemplated that the cutting assembly 12 could have pins extending from a bottom thereof that are configured to be inserted into the openings to connect the cutting assembly 12 to the mobile base 14.

The mobile cart 14 is configured to be rolled adjacent a table with the bar 62 located adjacent a side edge of the table, the upper plate 60 located directly above a top of the table and the I-shaped base 64 located below the table. Therefore, the garlic bread slicer 10 can easily be used with a table to cut the garlic bread and place the garlic bread on the table after the bread has been cut. Thereafter, the garlic bread slicer 10 can be easily rolled away to be stored when not in use.

In the forgoing description, it will be readily appreciated by those skilled in the art that modifications may be made to the invention without departing from the concepts disclosed herein. Such modifications are to be considered as included in the following claims, unless these claims by their language expressly state otherwise.

We claim:

1. A food slicer comprising:
a base comprising a slanted chute and a cutting blade housing;
the slanted chute comprising a first panel and a second panel, the first panel including a first wall and the second panel including a second wall, the first wall facing the second wall;
the cutting blade housing including a cutting blade extending into the chute;
wherein food can be placed into a top of the slanted chute and be forced to slide to a bottom of the chute by gravity, whereby the food placed into the slanted chute is sliced by the cutting blade as the food slides through the slanted chute;
wherein the first panel and the second panel of the slanted chute define a cavity for receiving food therein;
wherein the first panel is adjustably positioned relative to the second panel whereby the first wall of the first panel can be towards and away from the second wall of the second panel, thereby altering the size of the cavity in the slanted chute; and
wherein the cavity has a uniform cross section from the top of the chute to the bottom of the chute.

2. The food slicer of claim 1, wherein:
the uniform cross section is rectangular.

3. The food slicer of claim 1, wherein:
the first panel is C-shaped and further includes a top wall and a bottom wall, with the first wall connecting the top wall and the bottom wall.

4. The food slicer of claim 1, wherein:
the first wall and the second wall are planar.

5. The food slicer of claim 1, further including:
a motor located within the base for rotating the cutting blade.

6. The food slicer of claim 5, wherein:
the cutting blade is annular.

7. The food slicer of claim 1, wherein:
the base includes a plate having a pair of slots therethrough;
the first panel includes a pair of threaded fasteners extending therefrom and through the slots;
screw clamps are located on ends of the threaded fasteners, whereby the screw clamps can be unscrewed to allow the first wall of the first panel to move towards and away from the second wall of the second panel and screwed to lock the first wall of the first panel into position relative to the second wall of the second panel.

8. The food slicer of claim 1, wherein:
the base includes apertures in a bottom thereof for accepting fasteners to connect the food slicer to a mobile cart to allow easy transportation of the food slicer.

9. The food slicer of claim 9, wherein:
the apertures are threaded.

10. A mobile food slicer assembly comprising:
a base comprising a slanted chute and a cutting blade housing, the cutting blade housing including a cutting blade extending into the chute, the base further including apertures in a bottom thereof; and
a mobile cart having wheels on a bottom thereof and a top frame member, the top frame member including a plurality of openings;
wherein the openings and the apertures are configured to accept fasteners therethrough to connect the bar to the mobile cart to thereby allow easy transportation of the base on the mobile cart and to steady the base during use of the cutting blade; and
wherein food can be placed into a top of the slanted chute and be forced to slide to a bottom of the chute by gravity, whereby the food placed into the slanted chute is sliced by the cutting blade as the food slides through the slanted chute.

11. The mobile food slicer assembly of claim 10, wherein:
the slanted chute comprises a first panel and a second panel, the first panel including a first wall and the second panel including a second wall, the first wall facing the second wall;
the first panel and the second panel of the slanted chute define a cavity for receiving food therein;
the first panel is adjustably positioned relative to the second panel whereby the first wall of the first panel can be towards and away from the second wall of the second panel, thereby altering the size of the cavity in the slanted chute; and
the cavity has a uniform cross section from the top of the chute to the bottom of the chute.

12. The mobile food slicer assembly of claim 11, wherein:
the uniform cross section is rectangular.

13. The mobile food slicer assembly of claim 11, wherein:
the first panel is C-shaped and further includes a top wall and a bottom wall, with the first wall connecting the top wall and the bottom wall.

14. The mobile food slicer assembly of claim 11, wherein:
the first wall and the second wall are planar.

15. The mobile food slicer assembly of claim 11, wherein:
the base includes a plate having a pair of slots therethrough;
the first panel includes a pair of threaded fasteners extending therefrom and through the slots;
screw clamps are located on ends of the threaded fasteners, whereby the screw clamps can be unscrewed to allow the first wall of the first panel to move towards and away from the second wall of the second panel and screwed to lock the first wall of the first panel into position relative to the second wall of the second panel.

16. The mobile food slicer assembly of claim 10, further including:
a motor located within the base for rotating the cutting blade.

17. The mobile food slicer assembly of claim 16, wherein:
the cutting blade is annular.

18. The mobile food slicer assembly of claim 10, wherein:
the apertures are threaded.

19. A mobile food slicer assembly comprising:
a base comprising a slanted chute and a cutting blade housing, the base including apertures in a bottom thereof;
the slanted chute comprising a first panel and a second panel, the first panel including a first wall and the second panel including a second wall, the first wall facing the second wall;
the cutting blade housing including a cutting blade extending into the chute; and
a mobile cart having wheels on a bottom thereof and a top frame member, the top frame member including a plurality of openings;
wherein the openings and the apertures are configured to accept to fasteners therethrough to connect the base to the mobile cart to thereby allow easy transportation of the base on the mobile cart and to steady the base during use of the cutting blade; and
wherein food can be placed into a top of the slanted chute and be forced to slide to a bottom of the chute by gravity, whereby the food placed into the slanted chute is sliced by the cutting blade as the food slides through the slanted chute;
wherein the first panel and the second panel of the slanted chute define a cavity for receiving food therein;
wherein the first panel is adjustably positioned relative to the second panel whereby the first wall of the first panel can be moved towards and away from the second wall of the second panel, thereby altering the size of the cavity in the slanted chute; and
wherein the cavity has a uniform cross section from the top of the chute to the bottom of the chute.

20. The mobile food slicer assembly of claim 19, wherein:
the apertures are threaded.
